(19) United States
(12) Patent Application Publication
(10) Pub. No.: US 2004/0095018 A1
(43) Pub. Date: May 20, 2004

(54) Brake control systems

(76) Inventors: Christopher Stanford Baylis, Fourstones (GB); Edmond John Wimbush Harrison, Leamington Spa (GB); Michael Edgar Naylor, Nether Whitacre (GB)

Correspondence Address: Robert L Stearns, Howard & Howard Attorneys, 39400 Woodward Avenue, Bloomfield Hills, MI, 48304-5151, US

(21) Appl. No.: 10/450,574

(22) PCT Filed: Dec. 17, 2001
(86) PCT No.: PCT/GB01/05551

(30) Foreign Application Priority Data
Dec. 16, 2000 (GB) 0030796.7

(51) Int. Cl. B60T 8/60

(52) U.S. Cl. 303/155

(57) ABSTRACT

An automotive braking system (10) comprises wheel brakes (12), a master cylinder assembly (18) and a pedal assembly (16) to actuate the master cylinder. The master cylinder comprises fast-fill and high pressure cylinder portions. The pedal assembly is adapted to change progressively the mechanical advantage or velocity ratio of the assembly throughout pedal travel so that in the first part of the movement its mechanical advantage is greater than in the second part of the movement. This is the opposite of what would be expected in a system which is not servo-assisted since the greatest force would be expected to be required in the second part of the movement when braking is occurring.

This invention relates to brake control systems and provides a method and apparatus typically for use in controlling an automotive braking system, particularly for use in relation to small and medium sized cars and automobiles, but which may find application (or some aspects may find application) somewhat more widely.

In general terms the invention is concerned with braking systems of the kind which currently and conventionally employ vacuum servo devices or equivalent servo systems. Indeed, such systems are widely employed in the automotive passenger vehicle market, with the result that the requirement for significant driver effort in relation to brake operations has significantly reduced and likewise braking system responsiveness has correspondingly increased. However, these advances have not been made without cost and the provision of a substantial vacuum servo represents a generally accepted original equipment cost in relation to all but the most economic of automotive model sectors.

Therefore, it would obviously be a significant advance if means could be devised which would enable the servo effect (currently obtained at the cost of a vacuum-operated thrust-generating device) to be obtained by some mere modification of existing brake system equipment and without the need for the addition of significant original equipment offsetting the servo device cost saving.

We have discovered that one approach to this question which appears likely to be capable of practical realisation is the use of an hydraulic master cylinder adapted to provide at least two operating characteristics namely a high-pressure (or so-called “servos”) portion of its operating stroke and a relatively lower pressure initial fast-fill or clearance take-up portion. In this way the master cylinder itself (and without the use of a servo device) is able to simulate the effect of a servo device.

However, actuation of the master cylinder in the manner required to achieve this result is not available using a conventional foot pedal and master cylinder assembly and some modification is needed accordingly.

With this in mind and with a view to providing a brake pedal and master cylinder assembly offering the possibility of servo-like operating characteristics at a very significantly reduced cost as compared with conventional arrangements therefor, the embodiments of the invention provide for use with and in combination with a master cylinder assembly providing stepped or graduated hydraulic operating characteristics, a pedal assembly for actuation by the driver, which complementarily cooperates therewith to offer in combination a close approximation to the desired servo characteristics.

By the expression “complementarily” in this connection is meant that the mechanical advantage (or ratio of distance moved by effort over distance moved by load) for the pedal automatically changes in the same or opposite direction to complement the corresponding stepped or the like change in the hydraulic ratio provided by the master cylinder assembly to simulate a servo.

Specifically, in the range of operation of the pedal and master cylinder assembly corresponding to preliminary brake application the arrangement is such that the master cylinder operates through a relatively large diameter (and therefore low pressure)fast-fill cylinder portion and in this sector of its operation the master cylinder is actuated by the pedal with the pedal having a high mechanical advantage which corresponds to a relatively small movement of the load for a given movement of the effort. In other words, the pedal provides a relatively large force for a given pedal effort. While this offsets the requirement of the larger piston diameter of the master cylinder in its fast-fill sector of operation, it is the exact opposite of what would be expected in a system which is not servo-assisted since it would be expected that the greatest force would be required in the second part of the movement when braking is occurring.

An example of the above-mentioned “exact opposite” arrangement is disclosed in GB 876 498 (Powrie) in which a variable mechanical advantage lever system is disclosed which varies (see page 2 at line 8): “ . . . from a high velocity ratio at the beginning of pedal travel to take up play or slack when the roller 26 engages with cam face 21 to a low velocity ratio when the roller 26 engages with cam face 20 after passing over rise 22. The lever thus has a high mechanical advantage when the brake shoes are in contact with the brake drums”.

In practical realisation, the master cylinder of the described embodiments usually has only two sectors in its operating range, namely the fast-fill sector and the high pressure sector. The change-over between these sectors occurs when the piston assembly of the master cylinder reaches a predetermined point in its travel locus and valve means operates to switch the hydraulic output of the master cylinder from the fast-fill portion to the high-pressure (relatively small diameter portion).

In the described embodiments, the change in pedal ratio is effected by arranging the pedal and, master-cylinder-actuating pedal output rod geometry appropriately, the arrangement is such that the output thrust rod progressively moves towards the pedal pivot as the pedal moves through its arc of actuation, whereby the moment arm of the lever constituted by the pedal in applying thrust to the rod progressively shortens. Thus, in the described embodiment the mechanical advantage of the pedal itself changes in a progressive seamless manner and this complements well the stepwise change in ratio of the master cylinder itself. So far as the driver is concerned, the offsetting effect of the oppositely changing actuation ratios of the mechanical and hydraulic pedal/master cylinder assembly is that there is provided a well-balanced cooperative effect in which the fast-fill brake-engagement initial stage occurs with a higher mechanical advantage to offset the thrust requirements of the large diameter piston, and this phase smoothly merges into the high pressure actuation phase in which the lower velocity ratio of the pedal at this stage well offsets the effect of the smaller diameter piston which effectively simulates the required servo effect.

It will be understood that the hydraulic “velocity ratios” provided by the fast-fill and high pressure portions of the master cylinder assembly's travel are matters for design selection. Likewise, the velocity ratio or mechanical advantage provided by the pedal assembly equally is a design variable which, for any given braking system, will be chosen to complement the chosen diameters of the master cylinder fast-fill and high pressure portions. For example, the larger the diameter of the fast fill portion, the greater the actuating force required for that portion of the master cylinder's piston travel and thus the higher the velocity ratio (distance moved by effort over distance moved by load) will need to be. Similar considerations apply to the high pressure portion of the travel of the master cylinder piston. Reference is hereby made to the co-pending application to be filed herewith under reference 30155/P350356GB relating to a master cylinder assembly.

So far as the broad aspects of the present invention are concerned, the chosen velocity ratios in respect of the mechanical aspects of the pedal assembly and of the hydraulic aspects of the master cylinder assembly are adapted to simulate the effect of a servo device. For example, the desired performance characteristic of an ability to apply a low pedal force for check braking increasing to a high pedal force typical of that required for stops of 0.5 g deceleration can be achieved in this way on the basis of automotive braking systems currently available to which a brake control system according to the invention is applied. Broadly, the pedal is arranged so that in the first part of its movement its mechanical advantage is greater than in the second part of that movement. This is the exact opposite of what would be expected in a system which is not servo-assisted since the greatest force would be expected to be required in the second part of the movement when braking is occurring.

Embodiments of the invention will now be described by way of example with reference to the accompanying drawings of which:

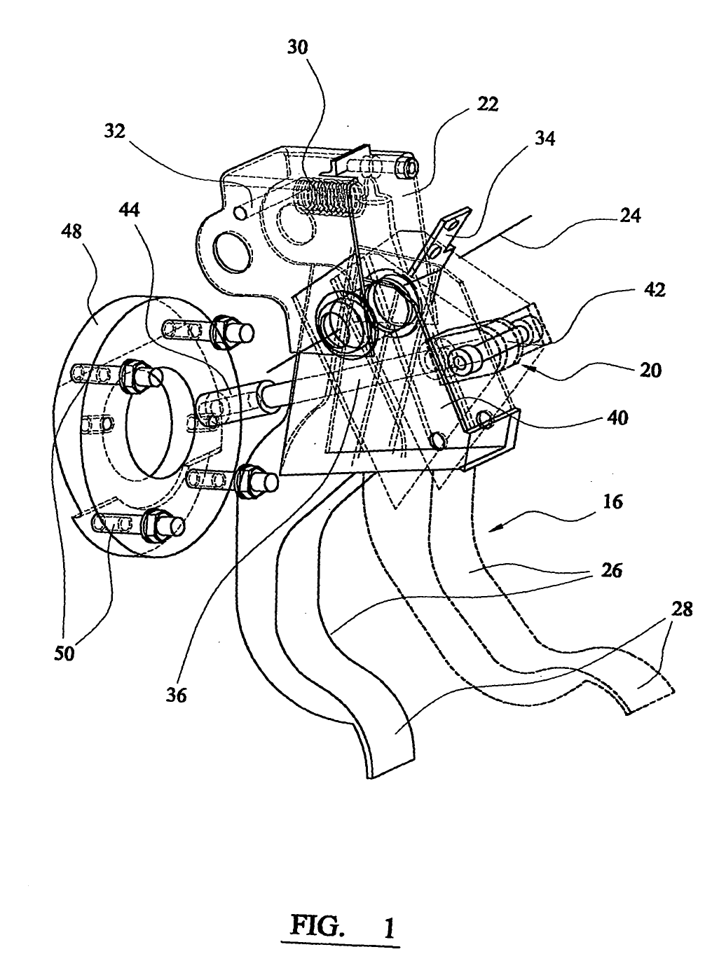

FIG. 1 shows a perspective view of a brake pedal assembly and an associated mounting for a master cylinder assembly together with a push rod for interconnecting same;

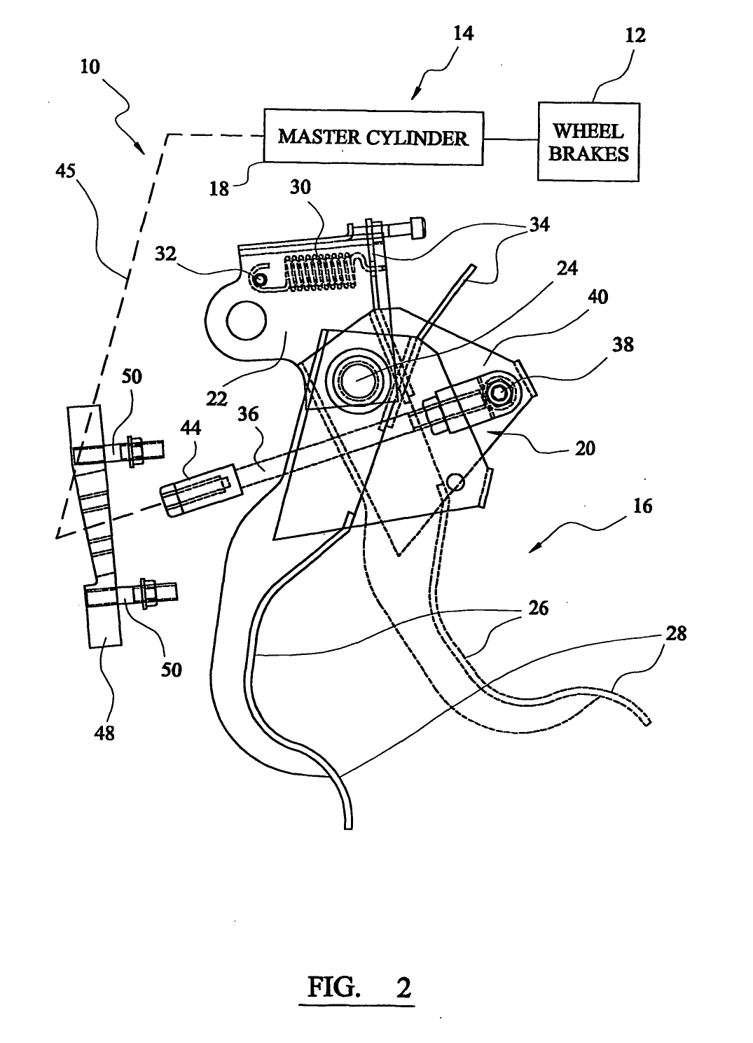

FIG. 2 shows a side elevation view of the brake pedal assembly of FIG. 1.

As shown in the drawings an automotive braking system 10 comprises wheel brake 12 having friction elements actuated by hydraulic actuated cylinders (not shown). A hydraulic control system 14 is provided for the wheel brakes and comprises a driver-operable brake foot pedal 16 arranged to actuate a hydraulic master cylinder 18 connected to the actuator cylinders of the wheel brakes.

Master cylinder 18 comprises tandem fast-fill and smaller diameter portions arranged, respectively, for (firstly) initial refilling of the recuperated hydraulic volume in the hydraulic system following completion of a previous brake operation and (secondly) high pressure application of the friction elements after initial engagement of same.

Master cylinder 18 is indicated non-illustratively since its construction may be in accordance with established practices.

Foot pedal assembly 16 comprises mechanical advantage change means 20 adapted to change the mechanical advantage or velocity ratio of the load applied by the pedal to master cylinder 18 as the pedal moves through its range of actuation movement seen in FIGS. 1 and 2.

In use, the mechanical advantage change means changes the mechanical advantage or velocity ratio of the load applied by pedal 16 to master cylinder 18 so that, for a given force applied to the pedal, the force applied to the master cylinder in its fast-fill range and the force applied to it in its higher pressure range using said smaller diameter cylinder portion are adapted to simulate the effect of a servo device by decreasing the mechanical advantage in the second part of the movement, which is the opposite of what would be required in a system which is not servo-assisted since the greatest force would be expected to be required in the second part of the movement when braking is occurring.

Details of the construction of pedal assembly 16 will now be further considered with reference to the drawings.

Foot pedal assembly 16 comprises a fixed upper bracket 22 defining a pivot axis 24 at which a profiled pedal member 26 is pivoted for angular movement between the positions shown in FIGS. 1 and 2 under the control of a drivers foot applied to the usual end foot pad 28.

A return spring 30 acts between a peg 32 and an upstanding return lever 34.

Interconnecting pedal member 26 and master cylinder 18 is a push rod 36 pivotally connected at 38 to a housing 40 fixed to pedal member 26 and pivotable therewith. The end of push rod 36 is connected by means of a trunnion connection 42 between the side plates of housing 40. The other end 44 has an end fitting for suitable connection via a connector 45 (shown diagrammatically) to master cylinder 18 and extends through a mounting 48 for the master cylinder and carried by bolts 50.

It can be readily seen from FIGS. 1 and 2 that as pedal member 26 moves between its upper release position to its lower actuated position, pedal member 26 which extends through the mounting ring 48 pivots about the axis of trunnion 42 somewhat and moves away from the pedal pivot axis 24, thereby progressively changing the mechanical advantage or velocity ratio of the lever drive to the push rod by increasing the length on the moment arm between the pivot axis 24 and the rod 36.

In the case of the geometry shown in FIGS. 1 and 2, it will be apparent that as push rod 36 moves away from axis 24 thereby increasing the length of the moment arm though which the load applied by the pedal is effectively transmitted to the push rod, and also moving the location of trunnion 42 towards the (approximately) 6 o'clock position with respect to pivot axis 24 at which linear movement of the rod lengthwise thereof is maximised, the progressive change as the brake pedal is actuated results in progressively greater rod movement and lower rod thrust for a given level of load applied to the pedal.

1. A method of controlling an automotive braking system comprising:
a) providing vehicle wheel brakes comprising friction elements actuated by hydraulic actuating cylinders;
b) providing a hydraulic control system for said vehicle wheel brakes comprising a driver-operable brake foot pedal arranged to actuate a hydraulic master cylinder connected to said actuating cylinders;
c) providing said master cylinder comprising tandem fast-fill and smaller diameter cylinder portions;
d) causing said pedal to actuate said master cylinder to actuate said wheel brakes;
characterised by
e) providing said pedal comprising mechanical advantage change means adapted to change the mechanical advantage with which the load applied to the pedal is applied to the master cylinder as the pedal moves through its range of actuating movement; and
f) causing said mechanical advantage change means to change the mechanical advantage with which the load applied to said pedal is applied to said master cylinder so that, for a given load applied to said pedal, the force applied to said master cylinder in a fast-fill range thereof is greater than the force applied thereto in a range using a smaller diameter cylinder portion thereof.

2. A method of controlling an automotive braking system comprising vehicle wheel brakes and a hydraulic control system therefor comprising a master cylinder and a foot pedal characterised by providing said pedal comprising mechanical advantage change means and causing same to change the mechanical advantage with which a load applied to the pedal is applied to the master cylinder so as to decrease the mechanical advantage with progressive travel of said pedal.

3. A method according to any one of claims 1 to 3 characterised by causing said mechanical advantage change means to progressively change the geometry of connection of said pedal to said master cylinder as said pedal is actuated.

4. An automotive braking system comprising:
a) vehicle wheel brakes comprising friction elements actuated by hydraulic actuating cylinders;
b) a hydraulic control system for said vehicle wheel brakes comprising a driver-operable brake foot pedal arranged to actuate a hydraulic master cylinder connected to said actuating cylinders; and
c) said master cylinder comprising tandem fast-fill and smaller diameter cylinder portions;
characterised by
d) said pedal comprising mechanical advantage change means adapted to change the mechanical advantage with which the load applied to the pedal is applied to the master cylinder as the pedal moves through its range of actuating movement; and
e) said mechanical advantage change means being adapted to change the mechanical advantage with which said load applied to said pedal is applied to said master cylinder so that, for a given force applied to said pedal, the force applied to said master cylinder in a fast-fill range thereof is greater than the force applied thereto in a range using a smaller diameter cylinder portion thereof.

5. An automotive braking system comprising vehicle wheel brakes and a hydraulic control system therefor comprising a master cylinder and a foot pedal characterised by said pedal comprising mechanical advantage change means adapted to change the mechanical advantage with which a load applied to the pedal is applied to the master cylinder so as to decrease the mechanical advantage with progressive travel of said pedal.

6. A system according to claims 4 or claim 5 characterised by causing said mechanical advantage change means to progressively change the geometry of connection of said pedal to said master cylinder as said pedal is actuated.
